(19) United States
(12) Patent Application Publication
(10) Pub. No.: US 2007/0048410 A1
(43) Pub. Date: Mar. 1, 2007

(54) Plastic bag comprising ready-to-cook fresh vegetables and a pouch comprising a flavoring composition

(76) Inventors: Cecilia Rojas de Gante, Guadalupe (MX); Juan Antonio Nevero Munoz, Guadalupe (MX)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/245,675

(22) Filed: Oct. 7, 2005

(30) Foreign Application Priority Data
Sep. 1, 2005 (EP) 05108008.3

(51) Int. Cl. A23B 7/148

(52) U.S. Cl. 426/106

(57) ABSTRACT

The present invention relates to a plastic bag comprising ready-to-cook fresh vegetables and a pouch comprising a flavoring composition, wherein said pouch essentially disintegrates under conditions of a relative humidity of at least 75% and a temperature in the range of 60°-110° C. The plastic bag is made by packaging the ready-to-cook fresh vegetables and the pouch in the plastic bag and heat-sealing the bag.

### 1. FIELD OF THE INVENTION

The present invention relates to a plastic bag comprising ready-to-cook fresh vegetables and a pouch comprising a flavoring composition. The present invention further relates to a pouch comprising a flavoring composition packaged in a plastic bag comprising ready-to-cook fresh vegetables.

### BACKGROUND OF THE INVENTION

Plastic bags comprising ready-to-cook food products, e.g. fresh vegetables, are commonly known in the art. Usually, the food is prepared by heating the bag in a microwave or steam oven for a relatively short period of time where after it is ready for consumption. However, usually it is desired to enhance the taste or appeal of the food product by flavoring the food product with a flavoring composition, e.g. seasonings or a sauce, after cooking the food product. In particular, if it is desired to flavor the food product with a flavoring composition in liquid form, the flavoring composition must be separately prepared and pre-heated prior to or during cooking of the food product, where after the flavoring composition can be added. Such flavoring compositions are also often provided together with the plastic bag comprising the food product and are attached on the exterior of the plastic bag.

Plastic bags comprising ready-to-cook food products wherein the food product is already flavored with a flavoring composition are also known in the art. However, it is not always desired that the food product, in particular if the food product comprises fresh vegetables, is in contact with the flavoring composition for a prolonged period of time, e.g. during storage, since this is detrimental to the taste and appeal of the food product. This is even more the case if the flavoring composition is in liquid form, e.g. a dressing or a sauce, as will be apparent to the person skilled in the art.

Packaging plastic bags for food products also well known in the art, wherein it is desired that the food product is kept fresh during storage, is protected from the environmental atmosphere to enhance shelf life and to prevent deterioration of the food product and to retain the original flavor of the food product. Such packaging bags must comprise a gas protecting layer or gas barrier layer to prevent that gases such as oxygen and water vapor come into contact with the food product. Gas barrier layers are also well known in the art and may comprise materials such as polyvinyl alcohol, polyvinyl chloride, ethylene vinyl acetate, a polyamide and the like.

For example, CA A 2.442.352 discloses a film made of polyvinyl alcohol for packaging meat products, in particular ham, which can subsequently be cooked or smoked. During the cooking or smoking process, the film may dissolve or disintegrate. The film may further be provided with a layer of flavor or with a separate layer of a flavor film so that during the cooking or smoking process the flavor is transferred to the food product. However, the packaging according to CA A 2.442.352 does not enable for the use of a flavoring composition, in particular a liquid flavoring composition, that may not be in contact with the meat product prior to cooking or smoking.

EP A 454.850 discloses a multilayer film for packaging food products, said multilayer film comprising a resin composition comprising a blend of a first polyvinyl alcohol copolymer and a second polymer selected from the group consisting of another polyvinyl alcohol copolymer, a polyamide and an olefin-vinyl acetate copolymer. The multilayer film is said to have for example excellent gas barrier properties, flavor retaining properties and heat sealability. However, the multilayer film according to EP A 454.850 does not disintegrate during cooking of the food product and is therefore not suitable for the manufacture of a pouch comprising a flavoring composition, in particular a liquid flavoring composition, that can be included in a plastic bag comprising ready-to-cook food products.

U.S. Pat. No. 5,318,812 discloses a packaging film for packaging food, in particular cheese, said packaging film comprising a gas barrier layer, wherein the gas barrier layer constitutes a blend of a polyvinyl alcohol and a compound giving a carbon dioxide/oxygen solubility ratio of 30 or higher, wherein the compound is selected from the group of alkylene glycol, hydroxy acid monomer and polymers thereof. This packaging film, however, does also not disintegrate during a cooking process.

### 2. SUMMARY OF THE INVENTION

The packaging films or bags according to the prior art have one or more disadvantages as disclosed above. Consequently, it would therefore be highly desirable to provide a plastic bag comprising ready-to-cook food products, in particular fresh food products and even more in particular fresh vegetables such as broccoli florets and cut carrots, as well as a flavoring composition, in particular if the latter is in liquid form, wherein the food product and the flavoring composition are not brought into contact with each other until the food product is prepared. The present invention therefore relates to a plastic bag comprising ready-to-cook fresh vegetables and a pouch comprising a flavoring composition, wherein said pouch essentially disintegrates under conditions of a relative humidity of at least 75% and a temperature in the range of 60°-110° C. In particular, the pouch disintegrates under conditions that prevail during cooking in a microwave oven. The present invention also relates to a process for packaging ready-to-cook fresh vegetables and a pouch comprising a flavoring composition in a plastic bag, wherein said pouch essentially disintegrates under conditions of a relative humidity of at least 75% and a temperature in the range of 60°-110° C. and most preferably under conditions prevailing during cooking in a microwave oven.

### 3. DETAILED DESCRIPTION OF THE INVENTION

According to the invention, the pouch essentially disintegrates under conditions of a relative humidity of at least 75%, preferably of at least 85% and more preferably of at least 95% and a temperature in the range of 60°-110° C., more preferably in the range of 80°-110° C. and in particular in the range of 95°-110° C. In particular, the pouch disintegrates under conditions that prevail during cooking in a microwave oven.

According to the invention, it is preferred that the pouch is within the plastic bag.

The pouch has a high solubility in hot water and it is preferred that at 60° C. it dissolves within two minutes. Advantages of the plastic bag comprising the fresh vegetable and the pouch comprising the flavoring composition is that while preparing or cooking the vegetables it is flavored at the same time since the pouch disintegrates. A further advantage of the plastic bag according to the invention is that it can be stored under cooled conditions for a considerably long time during which important characteristics, e.g. organoleptic properties, color, nutritional value and vitamin content, do not deteriorate. The fresh vegetables packaged in the plastic bag according to the present invention has further a shelf life of at least 12 days under the conditions of 3° C. ±1° C. and a relative humidity of 96±2%.

As is well known to the person skilled in the art, fresh vegetables are often packaged under a protecting atmosphere and loose in quality, freshness and color when the fresh vegetables are subjected to high oxygen concentrations. In addition, some vegetables, e.g. broccoli, are known as “high respiring”, i.e. that these vegetables produce relatively high amounts of carbon dioxide.

Other problems encountered with plastic water-impermeable packages comprising fresh vegetables having high moisture content is that upon storage condensation of water vapor occurs. Such condensation phenomena are detrimental to the quality and freshness of the packaged vegetables and increase the risks of microbial growth. In such circumstances, it is often required to employ gas permeable plastic packages.

The plastic bag according to the present invention therefore preferably comprises a multilayer packaging film that combines desired properties such as gas barrier properties, strength, heat sealability and strechability, and that is suitable for being made into a bag by preferably a form-fill-seal process, either vertically or horizontally. Preferably, the multilayer packaging film is provided with at least one heat sealable layer and a gas barrier layer.

When the multilayer packaging film is made into a bag, it is preferred that the inner layer of the bag is the heat sealable layer. The sealing operation is usually performed inside versus inside, that is that the first transverse seal is made to shape the film into a tube which is then transported to the top and bottom sealing bars where the bag is actually made. However, inside versus inside sealing has certain disadvantages since it results in the formation of thick spots at the positions where the transverse seals cross the bottom and top seals as is disclosed in for example U.S. Pat. No. 6,094,889, incorporated by reference herein, so that for certain applications heat seal layers are employed that allow inside versus outside sealing operations.

The heat sealable layer is preferably selected from the group consisting of homopolymers and copolymers of monomers selected from the group consisting of C₂-C₁₂ α-olefins, wherein the homopolymers and copolymers have a density of 0.86-0.92, preferably 0.88-0.915 g/cm³ according to ASTM D 1505, a melt flow rate (190° C., 2.16 kg) of 0.1-50, preferably 1-20 g/10 min according to ASTM D 1238, a molecular weight distribution M_{w}/Mₙ of 1-3, preferably 1.2-2.5; low density polyethylenes having a density of 0.88-0.93, preferably 0.90-0.92 g/cm³ according to ASTM D 1505; ethylene vinyl acetate copolymers having a vinyl acetate content of 1-20 wt. %, preferably 3-12 wt %, and blends thereof.

The appropriate gas barrier layer depends from the required properties. For example, it is well known in the art that there are not many materials that provide a high barrier to both oxygen and water vapor so that often multilayer film are required wherein one inner layer provides a high barrier against oxygen whereas another inner layer provides a high barrier against water vapor. However, materials like PVC and polyamides, in particular nylon, can provide both properties. The gas barrier layer is preferably selected from the group of ethylene vinyl acetate copolymer, polyamide, polyvinyl chloride and blends thereof.

According to the present invention, a most suitable packaging film is CPM 4090A Produce Film of Sealed Air Corporation.

Besides the heat sealable layer(s) and gas barrier layer(s), the multilayer film may comprise further layers, e.g. layers that provide higher toughness, clarity, stiffness, strength and the like, e.g. a polypropylene or an ethylene propylene copolymer layer.

The multilayer may also be oriented, either in the machine direction or in the transverse direction (uniaxial orientation), or both (biaxial orientation).

The multilayer film may be manufactured by lamination or co-extrusion, preferably by co-extrusion, where after the film is optionally oriented as disclosed above. Preferably the multilayer film is co-extruded by the double bubble process as disclosed in U.S. Pat. No. 3,456,044.

According to a preferred embodiment of the present invention, the multilayer packaging film has an oxygen gas transmission rate at 25° C./0% RH according to ASTM D 3985 of less than 2000 cm³/m².day.atm, preferably less than 1500, more preferably less than 1300, even more preferably less than 1200 and in particular less than 1100 cm³/m².day.atm.

As disclosed above, vegetables are classified as “low respiring”, “medium respiring” and “high respiring”. Examples of “low respiring” vegetables include grapes and carrots. Examples of “medium respiring” vegetables include lettuce and an example of a “high respiring” vegetable is broccoli. According to the invention, the respiration rate is less than 10 ml CO₂/kg.hr if the vegetable is “low respiring”. If the vegetable is “medium respiring”, the respiration rate is 10-20 whereas if the vegetable is “high respiring”, the respiration rate is greater than 20 up to 100. The terms “low respiring” etc. are known in the art (cf. Table 1 of Post harvest Physiology of Vegetables, J. Welchmann, Marcel Dekker, Inc., New York, 1987, page 33). According to the present invention, the vegetable is preferably of the “high respiring” type, is more preferably a member of the genus Brassica oleracea and is in particular broccoli.

Additionally, it is preferred according to the present invention that the multilayer packaging film has a CO₂ transmission rate of at least 750 cm³ m².day.atm at 25° C., more preferably at least 1000, most preferably at least 1200. The CO₂ transmission is measured using an analytical technique analogous to ASTM D 3985. The ratio of the CO₂ transmission rate to O₂ transmission rate is preferably greater than 3:1 and less than 5:1.

The pouch according to the present invention is also manufactured from a heat sealable film. Obviously, this heat sealable film must disintegrate under conditions that prevail in the plastic bag comprising the vegetables when the latter is heated in a microwave oven. Furthermore, this heat sealable film must disintegrate and preferably the film is also soluble in hot water or hot water vapor. Obviously, it is the main “functionality” or “activity” of the pouch to be soluble or capable to disintegrate only in hot water or in hot water vapor that is generated during the heating process. Hence, according to the invention, the heat sealable film used for the manufacture of the pouch has preferably a water vapor transmission rate at 25° C./85% RH according to ASTM E 96 of less than 500 g/m².day.atm.

Since the pouch will usually contain very low amounts of oxygen, the oxygen transmission rate of the heat sealable film used for the manufacture of the pouch is not very critical. However, it is preferred that the oxygen transmission rate at 25° C./85% RH according to ASTM D 3985 is 1,000 cm³ m².day.atm.

Preferably, the heat sealable film used for the manufacture of the pouch comprises one layer of polyvinyl alcohol polymer. More preferably, the heat sealable film used for the manufacture of the pouch is a single layer film consisting of polyvinyl alcohol polymer, wherein the polyvinyl alcohol polymer preferably comprises 0.1 to 50 wt. % of ethylene, more preferably 1 to 25 wt. %, and has a degree of saponification of 50-99%, preferably 60-90%, more preferably 60-85%. More preferably, the heat sealable film used for the manufacture of the pouch is a single layer film consisting of polyvinyl alcohol polymer, wherein the polyvinyl alcohol film is manufactured from powdered polyvinyl alcohol having a number average molecular weight Mn of 70 000-100 000. Such polyvinyl alcohols exhibit a viscosity of 11-14 cP (4% aqueous solution, 20° C.) and are only soluble in hot water/hot water vapor.

According to the present invention, it is preferred that the flavoring composition comprised by the pouch is a liquid composition, in particular a dressing of the type “escabeche”, which comprises maltodextrine, modified corn starch, vegetable oil, artificial flavours, natural flavours, Arabic gum, silicon dioxide (anti caking agent) and sugar. The dressing is made by mixing the escabeche in powder form and water and the concentration of the escabeche dressing is about 70-95 wt. % based on the dry weight.

The present invention also relates to a process for the manufacture of a plastic bag comprising ready-to-cook fresh vegetables and a pouch comprising a flavoring composition, wherein said pouch essentially disintegrates under conditions of a relative humidity of at least 75% and a temperature in the range of 60°-110° C., said process comprising the steps of:
(a) packaging the ready-to-cook fresh vegetables and the pouch in the plastic bag; and
(b) heat-sealing the bag.

Preferably, the plastic bag is manufactured in a form-fill-seal process, wherein a packaging film is made into a tube which is then heat sealed at the bottom to provide an open bag. The open bag is filled with the ready-to-cook vegetables and a pouch comprising the flavoring composition is applied by a fastening means, preferably double sided sticking tape that may be used in contact with food, to the interior of the open bag, preferably at a location remote from the ready-to-cook fresh vegetables, since it is preferred that the sticking tape does not come into contact with the vegetables. In a final step the open bag is sealed at the top.

When the plastic bag according to the invention is heated in a microwave, disintegration of the pouch occurs within the required cooking time. Then the bag can be shaken so as to provide the vegetables with the dressing, where after the bag is cut open and the vegetables provided with the dressing are served. During cooking, the sticking tape preferably remains adhered to the plastic bag.

### EXAMPLE 1

The polyvinyl alcohol film used for the manufacture of the pouch has the following properties (cf. Table 1).

TABLE 1

| Property | Value | Method |
|---|---|---|
| Thickness | 40 μm | |
| Strength tension | 1033-1110 Pa | ASTM D 882 |
| Elongation | 102-106% | ASTM D 882 |
| Oxygen gas | (1.0-1.5) × 10⁵ | ASTM D 3985 |
| transmission rate | cm³/m² · day · atm | |
| Water vapour | 0.5 g/m² · day · | ASTM E 69 |
| transmission rate | mm Hg | |

The polyvinyl alcohol film dissolves in water having a temperature of 60° C. within 1 minute and 28 seconds, in water having a temperature of 70° C. within 1 minute and 5 seconds, and in water having a temperature of 80° C. within 45 seconds.

The polyvinyl alcohol film was used to manufacture a pouch containing the escabeche dressing. A pouch having a size of about 11 by 4 cm was formed by heat sealing the film at three edges. The pouch was then filled with about 20 ml of the dressing and subsequently heat-sealed. All operations were performed using a Multivac sealer (heat seal temperature about 110° C., time about 4 s).

Pre-selected, washed broccoli florets and the pouch comprising the escabeche dressing were packaged using a packaging film CPM 4090A from Sealed Air Corporation having a total thickness of about 60 μm, wherein the film was formed into a plastic bag having a size of approximately 17 by 30 cm.

### EXAMPLE 2

The shelf life of four samples (E1-E4) made according to the method disclosed in Example 1 was tested at 4° C. and 75% RH. The following parameters were evaluated at day 0, day 5 and day 11.

TABLE 2
Obtained values for each parameter when initiating the evaluation during the storage
of the system: Package-Broccoli-Active Package in ‘escabeche’ flavor.

| Parameter | E1 | E2 | E3 | E4 |
|---|---|---|---|---|
| System average weight (gr | 243 | 243 | 243 | 243 |
| c/σ ± 5% of average weight) | | | | |
| Brocoli's Color | L = 33.38 | L = 32.40 | L = 34.90 | L = 34.53 |
| (Hunter-Lab scale) | a = −9.70 | a = −9.80 | a = −10.30 | a = −10.68 |
| | b = 11.80 | b = 8.90 | b = 11.40 | b = 12.85 |
| Dressing volume (mL) | 25 | 25 | 25 | 25 |
| Dressing Color | L = 37.97 | L = 31.97 | L = 31.97 | L = 32.40 |
| (Hunter-Lab scale) | a = 12.18 | a = 9.07 | a = 9.31 | a = 10.20 |
| | b = 21.18 | b = 16.33 | b = 6.48 | b = 17.55 |
| PVOH package thickness (μm) | 0.0947 | 0.0947 | 0.0947 | 0.0947 |
| (c/σ per package ± 25%) | | | | |
| Microwave solubility | Y | Y | Y | Y |
| (Yes: Completely soluble | | | | |
| No: Partially soluble) | | | | |
| Scent & Flavor | Acceptable | Acceptable | Acceptable | Acceptable |
| (acceptable - non acceptable) | | | | |

TABLE 3
Obtained values for each parameter to day 5 of evaluation during the storage
of the system: Package-Broccoli-Active Package in escabeche flavor.

| Parameter | E1 | E2 | E3 | E4 |
|---|---|---|---|---|
| Global System weight (gr) | 243 | 242 | 243 | 244 |
| Broccoli's Color | L = 32.60 | L = 33.30 | L = 36.29 | L = 32.78 |
| (Hunter-Lab scale) | a = −9.00 | a = −8.80 | a = −11.40 | a = −9.10 |
| | b = 9.53 | b = 9.30 | b =13.15 | b = 11.44 |
| Dressing volume (mL) | 26 | 27 | 26 | 26 |
| Dressing Color | L = 32.17 | L = 32.79 | L = 33.86 | L = 26.57 |
| (Hunter-Lab scale) | a = 8.61 | a = 10.00 | a = 11.62 | a = 6.70 |
| | b = 16.16 | b = 17.90 | b = 18.53 | b = 12.55 |
| PVOH package Thickness (μm) | 0.144 | 0.130 | 0.128 | 0.123 |
| Microwave solubility | N | Y | Y | Y |
| (Yes: Completely soluble | | | | |
| No: Partially soluble) | | | | |
| Scent & Flavor | Acceptable | Acceptable | Acceptable | Acceptable |
| (acceptable - non acceptable) | | | | |

TABLE 4
Obtained values for each parameter to day 11 of evaluation during the storage
of the system: Package-Broccoli-Active Package in escabeche flavor.

| Parameter | E1 | E2 | E3 | E4 |
|---|---|---|---|---|
| Global System weight (gr) | 243 | 242 | 243 | 244 |
| Broccoli 's Color | L = 33.90 | L = 32.81 | L = 31.10 | L = 34.00 |
| (Hunter-Lab scale) | a = −10.40 | a = −9.35 | a = −9.10 | a = −10.30 |
| | b = 12.60 | b = 11.01 | b = 16.64 | b = 14.00 |
| Dressing volume (mL) | 28 | 29 | 27 | 28 |
| Dressing Color | L = 30.74 | L = 34.10 | L = 29.84 | L = 28.30 |
| (Hunter-Lab scale) | a = 7.88 | a = 9.25 | a = 10.73 | a = 7.75 |
| | b = 15.90 | b = 14.67 | b = 12.33 | b = 12.30 |
| PVOH package Thickness (μm) | 0.075 | 0.082 | 0.079 | 0.081 |
| Microwave solubility | N | Y | Y | Y |
| (Yes: Completely soluble | | | | |
| No: Partially soluble) | | | | |
| Scent & Flavor | Acceptable | Acceptable | Acceptable | Acceptable |
| (acceptable - non acceptable) | | | | |

What is claimed is:

1. A plastic bag comprising ready-to-cook fresh vegetables and a pouch comprising a flavoring composition, wherein said pouch essentially disintegrates under conditions of a relative humidity of at least 75% and a temperature in the range of 60°-110° C.

2. Plastic bag according to claim 1, wherein the plastic bag comprises a multilayer packaging film.

3. Plastic bag according to claim 2, wherein the multilayer packaging film comprises a gas barrier layer.

4. Plastic bag according to claim 3, wherein the multilayer packaging film has an oxygen gas transmission rate at 25° C./0% RH according to ASTM D 3985 of less than 2000 cm³/m².day.atm.

5. Plastic bag according to claim 3 or claim 4, wherein the multilayer packaging film has a carbon dioxide transmission rate at 25° C./0% RH of at least 750 cm³/m².day.atm.

6. Plastic bag according to any one of claim 1, wherein the pouch has an oxygen gas transmission rate at 25° C./85% RH according to ASTM D 3985 of 1,000 cm³/m².day.atm.

7. Plastic bag according to any one of claim 1 or claim 6, wherein the pouch has a water vapor transmission rate at 25° C./85% RH according to ASTM E 96 of less than 500 g/m².day.atm.

8. Plastic bag according to claim 1, wherein the pouch comprises a film comprising a polyvinyl alcohol polymer, said polyvinyl alcohol polymer comprising 0, 1-50 percent by weight of ethylene and said polyvinyl alcohol polymer having a degree of saponification of 50-99%.

9. Plastic bag according to claim 8, wherein the polyvinyl alcohol polymer has a number average molecular weight Mₙ of 70,000.

10. Plastic bag according to any one of claim 8, wherein the film is a single layer film consisting of the polyvinyl alcohol polymer.

11. Plastic bag according to claim 1, wherein the flavoring composition is a liquid composition.

12. A process for packaging ready-to cook fresh vegetables and a pouch comprising a flavoring composition in a plastic bag, wherein said pouch essentially disintegrates under conditions of a relative humidity of at least 75% and a temperature in the range of 60°-110° C., said process comprising the steps of:
(a) packaging the ready-to-cook fresh vegetables and the pouch in the plastic bag; and
(b) heat-sealing the bag.

13. Process according to claim 12, wherein the pouch is manufactured in a form-fill-seal process.

14. Process according to claim 12 or claim 13, wherein the plastic bag is manufactured in a form-fill-seal process.

15. Process according to claim 14, wherein the pouch comprises a film comprising a polyvinyl alcohol polymer, said polyvinyl alcohol polymer comprising 0, 1-50 percent by weight of ethylene and said polyvinyl alcohol polymer having a degree of saponification of 50-99%.

16. Process according to claim 15, wherein the polyvinyl alcohol polymer has a number average molecular weight Mn of 70,000.

17. Process according to claim 15, wherein the film is a single layer film consisting of the polyvinyl alcohol polymer.
